(19) United States
(12) Patent Application Publication
(10) Pub. No.: US 2014/0088837 A1
(43) Pub. Date: Mar. 27, 2014

(54) Vehicle With Solicited Carriage Descent

(71) Applicants: Erric L. Heitmann, Liverpool, NY (US); John B. Kirk, Greene, WI (US)

(72) Inventors: Erric L. Heitmann, Liverpool, NY (US); John B. Kirk, Greene, WI (US)

(21) Appl. No.: 13/623,971

(22) Filed: Sep. 21, 2012

(51) Int. Cl. B66F 9/24; G06F 7/00

(52) U.S. Cl. 701/50

(57) ABSTRACT

A vehicle includes a vehicle frame, a vertical mast coupled to the vehicle frame, and a carriage movably mounted to the mast for ascending and descending along the mast. At least one hydraulic cylinder moves the carriage along the mast, a hydraulic pump pumps hydraulic fluid into the hydraulic cylinder, and a flow valve controls the flow of hydraulic fluid between the hydraulic pump and the hydraulic cylinder. A sensor senses an actual descent speed of the carriage and a controller controls the flow valve to allow descent of the carriage at a requested descent speed. The controller controls the flow valve to limit descent of the carriage to a unsolicited descent speed limit if a difference between the actual descent speed and the requested descent speed exceeds a threshold value.

### CROSS REFERENCES TO RELATED APPLICATIONS

Not Applicable

### STATEMENT REGARDING FEDERALLY SPONSORED RESEARCH

Not Applicable.

### BACKGROUND OF INVENTION

Material handling trucks include a carriage moveable up and down a mast and hydraulic cylinders to move the carriage. A hydraulic pump pumps hydraulic fluid into the hydraulic cylinders to force movement of pistons within the hydraulic cylinders and lift the carriage along the mast. When the carriage is lowered, hydraulic fluid is allowed to exit the cylinders. Hydraulic cylinders include a flow limiting valve that only permits flows of hydraulic fluid into and out of the hydraulic cylinders up to a flow limit value. The flow limiting valve ensures the carriage descent speed is limited in the event of an unsolicited descent of the carriage. Unfortunately, the flow limiting valve also limits the carriage descent speeds when the operator requests that the carriage lift or lower. In warehouse storage environments, the productivity of material handling vehicles is partly based on how many pallets can be raised or lowered per hour from shelving. Limiting the carriage speed of solicited descents thus limits the productivity of the material handling vehicle.

Therefore, a need exists for a system that only limits carriage descent speeds in the event of an unsolicited carriage descent.

### SUMMARY OF THE INVENTION

The present invention provides a vehicle including a vehicle frame, a vertical mast coupled to the vehicle frame, and a carriage movably mounted to the mast for ascending and descending along the mast. The vehicle also includes one or more hydraulic cylinders moving the carriage along the mast, a hydraulic pump pumping hydraulic fluid into the hydraulic cylinder, and a flow valve controlling the flow of hydraulic fluid between the hydraulic pump and the hydraulic cylinder. The vehicle further includes a sensor sensing an actual descent speed of the carriage and a controller controlling the flow valve to allow descent of the carriage at a requested descent speed. The controller controls the flow valve to limit descent of the carriage to an unsolicited descent speed limit if a difference between the actual descent speed and the requested descent speed exceeds a threshold value.

A general objective of the present invention is to control the descent speed of a carriage along a mast mounted to a frame of a vehicle. This objective is accomplished by determining a requested descent speed of the carriage, sensing an actual descent speed of the carriage, and comparing the requested descent speed and the actual descent speed to determine a difference value. This objective is further accomplished by comparing the difference value with a threshold value, and limiting the actual descent speed to an unsolicited descent speed limit if the difference value is greater than the threshold value.

The foregoing and other objects and advantages of the invention will appear from the following detailed description. In the description, reference is made to the accompanying drawings which illustrate a preferred embodiment of the invention.

### BRIEF DESCRIPTION OF THE DRAWINGS

FIG. 1 is a rear perspective view of a vehicle according to one embodiment of the invention.

FIG. 2 is another rear perspective view of the vehicle of FIG. 1.

FIG. 3 is a communication flow diagram of components of the vehicle of FIG. 1.

FIG. 4 is a partial schematic view of a hydraulic system for use with the vehicle of FIG. 1.

FIG. 5 is a flow chart of example initialization and calibration operations of components of the vehicle of FIG. 1.

### DETAILED DESCRIPTION OF THE INVENTION

Conventional material handling vehicles limit the maximum descent speed of a carriage vertically movable along a mast to approximately 118 feet per minute. Advantageously, the vehicle described herein incorporating the present invention can achieve descent speeds greater than the standard maximum descent speed, while limiting descent speeds to an unsolicited descent speed limit during unsolicited carriage descents. In one embodiment, a vehicle controller controlling the carriage distinguishes a solicited carriage descent from an unsolicited carriage descent by comparing the actual speed of the carriage, as sensed by a sensor, with the descent speed requested by an operator, as further described below.

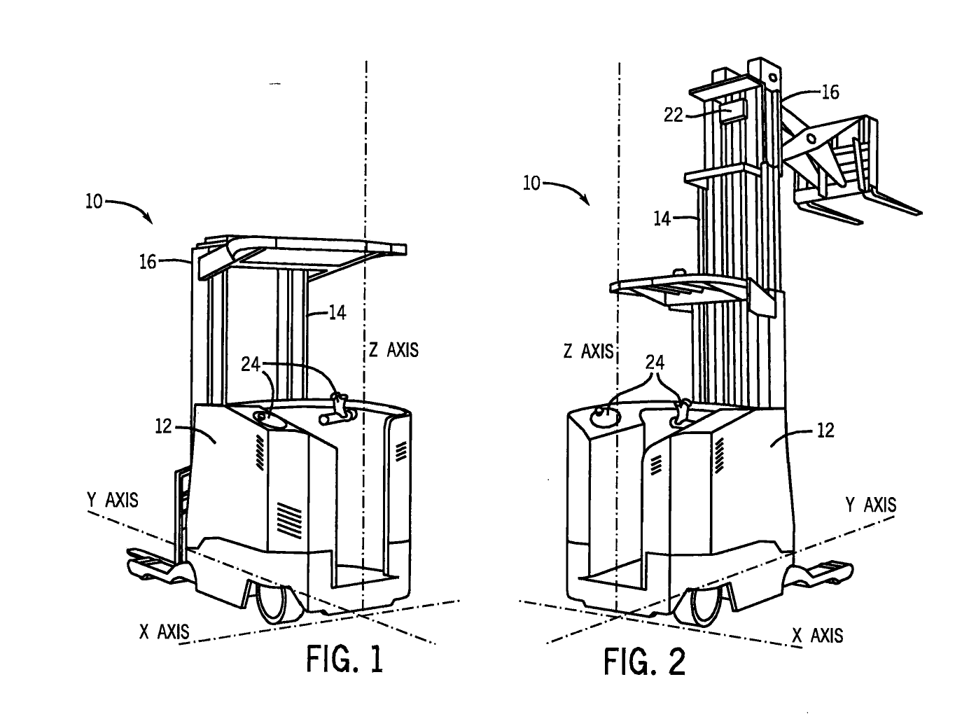

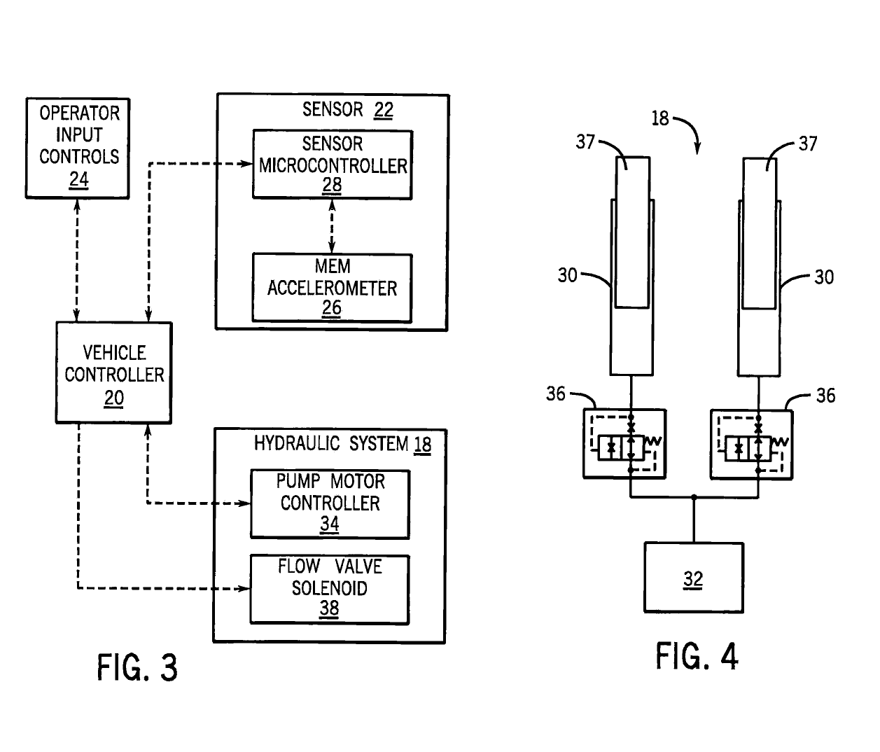

Referring to FIGS. 1 and 2, a material handling vehicle 10 includes a frame 12, a mast 14 coupled to the frame 12, and a carriage 16 moveable along the mast 14. A hydraulic system 18, as shown in FIGS. 3 and 4, is mounted on the vehicle 10 and raises and lowers the carriage 16 along the mast 14 in response to input from an operator. For example, FIG. 1 shows the carriage 16 in a lowered position and FIG. 2 shows the carriage 16 in a raised position. The hydraulic system 18 is solicited by a vehicle controller 20 that receives the operator input as well as other inputs from a sensor 22 that senses the vertical ascent or descent speed of the carriage 16. In the embodiment disclosed herein, the operator controls the hydraulic system 18, and thus the ascent and descent of the carriage 16 along the mast 14, through operator input controls 24 in communication with the vehicle controller 20. Example vehicles that can incorporate the present invention include Reach-Fork® Trucks or Swing-Reach® Trucks, manufactured by The Raymond Corporation of Greene, N.Y..

The hydraulic system 18 of the vehicle 10 includes one or more hydraulic cylinders 30, as shown in FIG. 4, a hydraulic pump 32, a pump motor controller 34, as shown in FIG. 3, and one or more flow valves 36. The hydraulic pump 32 is solicited by the pump motor controller 34 (e.g., in communication and solicited by the vehicle controller 20) to deliver hydraulic fluid to and from the hydraulic cylinders 30. More specifically, the hydraulic fluid flows through the hydraulic pump 32 into the hydraulic cylinders 30 (i.e., causing upward movement of pistons 37 within the hydraulic cylinders 30) to raise the carriage 16 and flows back through the hydraulic pump 32 from the hydraulic cylinders 32 (i.e., causing downward movement of the pistons 37) to control the carriage descent and provide regenerative energy for the vehicle 10.

The pump motor controller 34 can operate the hydraulic pump 32 at different speeds to control the amount of fluid flow to the hydraulic cylinders 30, which in turn controls the ascent or descent speed of the carriage 16. For example, given that the diameter of each hydraulic cylinder 30 is fixed, and the hydraulic pump 32 has a fixed fluid displacement per revolution, the movement speed of the carriage 16 is always a function of the pump rotational speed (e.g., measured in revolutions per minute, or RPM, of a motor of the pump 32) and the turning direction of the pump 32. Thus, under proper operating conditions, the following relationship holds true for converting carriage speed to pump rotation speed: Carriage Speed=K×RPM, where RPM<0 for descent, RPM>0 for ascent, and K is a constant.

In addition to the pump motor controller 34, the flow valves 36 also control the amount of fluid flow to the hydraulic cylinders 30, and therefore also control the ascent or descent speed of the carriage 16. Each flow valve 36 is located in a fluid path between the hydraulic pump 32 and the hydraulic cylinders 30 to selectively permit or limit flow between the hydraulic pump 32 and the hydraulic cylinders 30. Each flow valve 36 is in communication with the vehicle controller 20 so that the operating state of the flow valve 36 is dependent upon input from the vehicle controller 20. For example, if power is received from the vehicle controller 20, the flow valve 36 remains in a completely open state (i.e., a bypass state) to permit unlimited fluid flow between the hydraulic pump 32 and the hydraulic cylinders 30. If no power is received from the vehicle controller 20, the flow valve 36 is partially closed to act as a conventional flow limiting valve (i.e., in a throttled, or flow-limiting, state) and prevent fluid flows above a maximum flow value to prevent descent speeds above the unsolicited descent speed limit (e.g., about 118 feet per minute).

Accordingly, in the throttled state, the flow valve 36 limits fluid flow and power must be received by the vehicle controller 20 in order to change the operating state of the flow valve 36 to the bypass state. In order to accomplish this, each flow valve 36 includes a solenoid 38, as shown in FIG. 3. When the vehicle controller 20 provides power to the solenoid 38, the solenoid 38 holds the flow valve 36 open in the bypass state. Thus, when unlimited flow is allowable, the solenoid 38 receives power from the vehicle controller 20 and bypasses the flow valve's normal mechanical operation of limiting flows above a flow value corresponding to the unsolicited descent speed limit of the carriage. Without power, the solenoid 38 does not keep the flow valve 36 open and flow will be limited to the flow value corresponding to the unsolicited descent speed limit of the carriage. In some embodiments, the solenoid 38 and the flow valve 36 can be integral with or mounted on the hydraulic cylinder 30. In addition, other embodiments of the invention can include other combinations of mechanical and/or electrical components to duplicate the above-described function of a flow limiting valve that can be bypassed by applying electrical power.

During normal vehicle operation in which an operator solicits carriage descents and lifts, the flow valves 36 are in the bypass state and the vehicle controller 20 provides power to the solenoid 38 in order to allow unlimited flow to and from the hydraulic cylinders 30. In the event of an unsolicited descent, the vehicle controller 20 cuts power to the solenoid 38 in order to limit flow. In order to determine an unsolicited descent, the actual carriage speed is detected by the sensor 22 shown in FIG. 3. Preferably, the sensor 22 is mounted to the carriage 16 and includes a solid state microelectromechanical (MEM) accelerometer 26. The MEM accelerometer allows the sensor 22 to measure the vertical speed of the carriage 16 (i.e., along its respective z-axis, as shown in FIG. 1), despite movement of the vehicle 10 along its respective x-axis and y-axis or tilting of the mast 14 while raising or lowering the carriage 16. Preferably, the sensor 22 includes an electrical connection with the vehicle's negative power line, as well as, an electrical connection with the vehicle controller 20. Through the vehicle controller 20 electrical connection, the sensor 22 receives power and transmits a carriage speed signal. The sensor 22 also includes a microcontroller 28 for interpreting the accelerometer measurements and communicating with the vehicle controller 20.

In some embodiments, other speed sensing devices can be used in place of the MEM accelerometer 26. In one example, magnetic sensors can be used to detect the passage of holes or bumps along the mast 14 over time to obtain the descent speed. In another example, optical, microwave, or ultrasonic sensors can measure the distance from the floor to the carriage 16, and the distance measurements can be differentiated to obtain the descent speed.

As described above, the vehicle controller 20, as shown in FIG. 2 being mounted on the vehicle frame 12, controls the flow valve 36 by providing or cutting power to the solenoid 38. The vehicle controller 20 also performs other functions related to the vehicle 10, including receiving operator inputs for lifting or lowering the carriage 16 and controlling ascent or descent of the carriage 16 according to the operator inputs. More specifically, with respect to carriage descent, the vehicle controller 20 receives a requested descent speed input from the operator input controls 24 and determines a hydraulic pump rotational speed necessary to achieve the requested carriage descent speed (e.g., using the conversion equation described above). The vehicle controller 20 then provides a speed control signal to the pump motor controller 34 to operate the hydraulic pump 32 at the determined pump motor speed. The vehicle controller 20 also receives feedback from the pump motor controller 34 that indicates the actual rotational speed of the pump 32. Using the actual rotational speed of the pump 32, the vehicle controller 20 then determines a calculated descent speed (e.g., by applying the conversion equation). In addition, in some vehicles, carriage descent is only a function of throttling valve action controlled by the operator, as opposed to the pump 32 being operated in a reverse (i.e., negative RPM) direction. In such instances, the requested descent speed is determined directly from operator input controls, such as an operator input control position or control signal generated by the operator input controls or from a control signal to the throttling valve generated by a controller receiving a control signal from the operator input controls.

The vehicle controller 20 is also in communication with the sensor 22, which measures the actual movement speed (“CSPEED”) of the carriage 16. The vehicle controller 20 receives a CSPEED signal from the sensor 22 and compares it to the requested descent speed described above. The vehicle controller 20 uses the requested descent speed received by the operator input controls 24 or the calculated descent speed as the requested descent speed for this comparison. The vehicle controller 20 then calculates a difference value, “DELTA”, for example in feet per minute, between the actual descent speed and the requested descent speed (e.g., DELTA=CSPEED−Requested Descent Speed). A negative DELTA value indicates the carriage 16 is descending slower than the pump rotational speed would indicate. Likewise, a positive DELTA value indicates the carriage descent speed is higher than the pump rotational speed indicates. Since the requested carriage speed is based on operator input, any difference between the requested carriage speed and the actual carriage speed can indicate unsolicited carriage motion.

As described above, the flow valve 36 throttles fluid flow unless the vehicle controller 20 sends power to the solenoid 38 (i.e., energizes the solenoid 38) to hold the flow valve 36 open. When the absolute value of DELTA exceeds a threshold, the vehicle controller 20 determines that carriage motion is unsolicited and cuts power to the solenoid 38 (i.e. de-energizes the solenoid 38), placing the control valve in the throttled state to limit descent speed of the carriage 16 to the unsolicited descent speed limit.

If the absolute value of DELTA remains below the threshold, the vehicle controller 20 determines that carriage movement is solicited and continues providing power to the solenoid 38 and, as a result, permits descent speeds above the unsolicited descent speed limit. This permits carriage descent speeds above the unsolicited descent speed limit only when carriage motion is solicited by the operator. Advantageously, if the vehicle controller 20 itself experiences a failure, the sensor 22 experiences a failure, or if communication between the solenoid 38 and the vehicle controller 20 or the sensor 22 and the vehicle controller 20 is impeded for any reason, the solenoid 38 will stop receiving power and will not be able to hold the flow valve 36 in the bypass state, therefore limiting the carriage descent speed to the unsolicited descent speed limit.

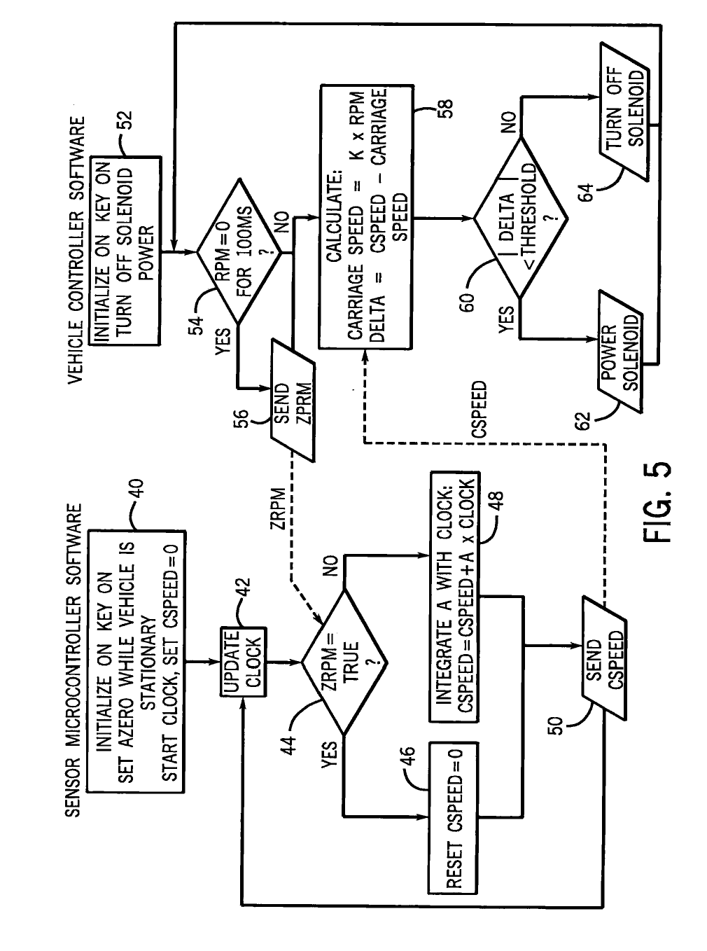

In addition to communicating the CSPEED signal, as described above, the sensor 22 and the vehicle controller 20 also communicate to perform one or more calibration procedures to maintain the accuracy of the sensor 22 over time and in varying operating conditions. For example, FIG. 5 illustrates steps performed by the sensor microcontroller 28 (process blocks 40-50) and the vehicle controller 20 (process blocks 52-64) in one embodiment to calibrate a zero acceleration signal (AZERO) and a zero pump speed signal (ZRPM), which can remove drifts in measurements commonly due to temperature and/or error accumulation over time. Communications between the sensor microcontroller 28 operations and the vehicle controller 20 operations are shown in FIG. 5 as dashed lines.

As shown in FIG. 5, both the sensor microcontroller 28 and the vehicle controller 20 perform initialization functions when power is provided to the vehicle 10 (i.e., at “KEY ON”) and periodically perform calibration functions to remove errors when the carriage 16 is not in motion. These operations both increase the accuracy of the sensor's speed signal and allow failsafe operation between the two components (e.g., so that unsolicited motion of the carriage 16 is correctly detected and result in the descent speed of the carriage being limited to the unsolicited descent speed limit). Referring to FIG. 5, on KEY ON (process block 40), the sensor microcontroller 28 determines the current output of the accelerometer 26 and records this value as the zero acceleration value, AZERO. In addition, on KEY ON (process block 52), the vehicle controller 20 ensures power is not being provided to the solenoid 38.

With further reference to the sensor microcontroller 28 functions of FIG. 5, following KEY ON, the sensor microcontroller 28 updates its clock (process block 42) and then determines if the zero pump speed signal, ZRPM, has been received by the vehicle controller 20, indicating that the carriage 16 is not in motion (process block 44). For example, the ZRPM signal can be generated when the hydraulic pump 32 has not been rotating (i.e., pump rotations per minute equal zero) for at least about 100 milliseconds. If the ZRPM signal has been received, the sensor microcontroller 28 resets the carriage speed signal CSPEED to zero (process block 46) and sends the updated speed signal CSPEED to the vehicle controller 20 (process block 50). If the ZRPM signal has not been received, the sensor microcontroller 28 updates CSPEED (process block 48) by adding the current stored CSPEED value to the product of the acceleration signal from the MEM accelerometer and the clock duration from the clock (i.e., CSPEED=CSPEED+A×CLOCK), and sends the updated CSPEED signal to the vehicle controller 20 (process block 50). After sending the updated CSPEED signal to the vehicle controller 20, the sensor microcontroller 28 repeats process blocks 42-50.

Once the zero acceleration signal is calibrated at least once, following KEY ON in the embodiment illustrated in FIG. 5, the vehicle controller 20 determines if the hydraulic pump speed has been at zero RPM for at least 100 milliseconds (process block 54). If the RPM of the pump 32 has been zero for at least 100 milliseconds, the vehicle controller 20 sends the ZRPM signal to the sensor microcontroller 28 (process block 56). If the RPM of the pump 32 has not been zero for at least 100 milliseconds, the vehicle controller 20 calculates the requested carriage speed using the received pump RPM from the motor controller 34 and the conversion equation described above (i.e., Carriage Speed=K×RPM), then calculates the difference value, DELTA, between the calculated speed and the last CSPEED value received from the sensor microcontroller 28 (process block 58). The vehicle controller 20 then determines if the absolute value of DELTA is greater or less than a threshold value (process block 60). If less than the threshold value, the vehicle controller 20 considers carriage motion to be solicited and provides power to the solenoid 38 to allow unlimited flow across the flow valve 36 (process block 62). If greater than the threshold value, the vehicle controller 20 considers carriage motion to be unsolicited and shuts off power to the solenoid 38 so that flow across the flow valve 36 is impeded to limit carriage descent speed to the unsolicited descent speed limit (process block 64). The vehicle controller 20 then repeats process blocks 54-64.

In some embodiments, the processes of the vehicle controller 20 (i.e., process blocks 54-64) and the sensor microcontroller 28 (i.e., process blocks 42-50) are repeated fifty or more times per second. In addition, in one embodiment, the sensor microcontroller process illustrated in FIG. 5 is the only function executed by the sensor microcontroller 28.

As described above, communications between the sensor microcontroller 28 and the vehicle controller 20 are transmitted in both directions. This two-way communication is implemented over a single communication line through Power Line Communication (PLC) or other similar methods. In one embodiment, over the electrical connection between the vehicle controller 20 and the sensor microcontroller 38, the vehicle controller 20 provides a fixed 5-volt power supply through a 100-ohm resistance or 500-ohm resistance. For example, the vehicle controller 20 normally applies 5 volts across the 100-ohm resistance and the sensor microcontroller 28 in turn sinks a current from about 4 milliamperes (mA) to about 20 mA to indicate the CSPEED value, as well as signal to the vehicle controller 20 that the sensor 22 is still connected and operating. Also, the vehicle controller 20 shifts from the 100-ohm resistance to the 500-ohm resistance to indicate that the pump 32 is not rotating (i.e., to communicate the ZRPM signal).

The purpose of the present invention is to retain all the desirable features of an unsolicited descent speed limit when unsolicited operation occurs, and permit lowering speeds beyond the unsolicited descent speed limit during solicited operation. Achieving faster descent speeds can increase productivity and, as a result, save labor costs. In addition, the faster descent speeds can further assist with energy regeneration of the vehicle 10 when using the hydraulic pump 32 as a generator. By constantly determining whether the carriage 16 is in solicited or unsolicited descent, the present invention provides a reliable method of reverting to the industry standard descent speed limit for unsolicited carriage descents. Such unsolicited carriage descents can be accurately and timely detected through constant calibration between the sensor 22 and the vehicle controller 20.

In addition, the system and methods of the present invention can be applied to different vehicle designs. For example, vehicles 10 without regenerative lowering may not include hydraulic pumps 32 that spin backwards during carriage descent. Such vehicles 10 alternately include an additional pressure sensor and/or flow measurement device (not shown) to determine the requested carriage speed value for comparison with the sensor measurements. In addition, such vehicles 10 use vacuum or pressure assistance between the hydraulic pump 32 and the double acting hydraulic cylinders 30 for controlling carriage descent. Other design changes in accordance with the present invention include large diameter tubing between the hydraulic pump 32 and the hydraulic cylinders 30 to permit higher flow rates back through the hydraulic pump 32.

While there has been shown and described what are at present considered the preferred embodiments of the invention, it will be obvious to those skilled in the art that various changes and modifications can be made therein without departing from the scope of the invention defined by the appended claims.

I claim:

1. A vehicle comprising:
a vehicle frame;
a vertical mast coupled to said vehicle frame;
a carriage movably mounted to said mast for ascending and descending along said mast;
at least one hydraulic cylinder moving said carriage along said mast;
a hydraulic pump pumping hydraulic fluid into said at least one hydraulic cylinder;
a flow valve controlling the flow of hydraulic fluid between said hydraulic pump and said at least one hydraulic cylinder;
a sensor sensing an actual descent speed of said carriage; and
a controller controlling said flow valve to allow descent of said carriage at a requested descent speed, said controller controlling said flow valve to limit descent of said carriage to an unsolicited descent speed limit if a difference between said actual descent speed and said requested descent speed exceeds a threshold value.

2. The vehicle as in claim 1, in which said controller controls said flow valve to allow descent of said carriage greater than said unsolicited descent speed limit if said difference between said actual descent speed and said requested descent speed is less than said threshold value.

3. The vehicle as in claim 2, in which said flow valve limits said flow of hydraulic fluid in order to limit descent of said carriage to said unsolicited descent speed limit, and said flow valve permits unlimited flow of hydraulic fluid in order to allow descent of said carriage above said unsolicited descent speed limit.

4. The vehicle as in claim 3, in which said flow valve is normally in a flow limiting operation state in order to limit said flow of hydraulic fluid, wherein said controller opens said flow valve to permit unlimited flow of hydraulic fluid.

5. The vehicle as in claim 4, including a solenoid coupled to said flow valve and solicited by said controller, wherein said flow valve is open when said solenoid is energized by said controller, and said flow valve is in said flow limiting operation state when said solenoid is de-energized.

6. The vehicle as in claim 1, in which said controller determines said requested descent speed by measuring a rotational speed of said hydraulic pump.

7. The vehicle as in claim 1, in which said sensor is a microelectromechanical accelerometer.

8. The vehicle as in claim 1, in which said controller is in communication with said sensor and receives said actual descent speed from said sensor.

9. The vehicle as in claim 8, in which said sensor includes a sensor microcontroller in communication with said controller, wherein said sensor microcontroller and said controller periodically perform a calibration procedure by said sensor microcontroller zeroing said actual descent speed when said controller determines a rotational speed of said hydraulic pump equal to zero.

10. The vehicle as in claim 9, in which said sensor microcontroller performs an initialization procedure when power is initially received by zeroing said actual descent speed.

11. The vehicle as in claim 1, in which said unsolicited descent speed limit is about 118 feet per minute.

12. The vehicle as in claim 1, in which said controller determines said requested descent speed directly from one of an operator control input signal, operator control position and a throttling valve control signal.

13. A method of controlling descent speed of a carriage along a mast mounted to a frame of a vehicle, said method comprising;
determining a requested descent speed of said carriage directly from a control signal;
sensing an actual descent speed of said carriage;
comparing said requested descent speed and said actual descent speed to determine a difference value;
comparing said difference value with a threshold value; and
limiting said actual descent speed to an unsolicited descent speed limit if said difference value is greater than said threshold value.

14. The method as in claim 13, including sensing said actual descent speed of said carriage using a sensor including a microelectromechanical accelerometer.

15. The method as in claim 14, including calibrating said sensor when said carriage is stationary to ensure sensing of said actual descent speed is accurate when said carriage is in motion.

16. The method as in claim 13, including allowing said actual descent speed to be above said unsolicited descent speed limit if said difference value is less than said threshold value.

17. The method as in claim 13, including limiting said actual descent speed by limiting a flow of hydraulic fluid through a hydraulic system that controls movement of said carriage.

18. The method as in claim 17, including limiting said flow of hydraulic fluid using a solenoid-solicited flow valve.

19. The method as in claim 13, including determining said requested descent speed from one of an operator control input signal and a throttling valve control signal.

20. The method as in claim 13, in which said unsolicited descent speed limit is about 118 feet per minute.
